(19) United States
(12) Patent Application Publication
(10) Pub. No.: US 2007/0294730 A1
(43) Pub. Date: Dec. 20, 2007

(54) Customizable on-screen display for data presentation

(76) Inventors: David E. Feldstein, Santa Monica, CA (US); Jon M. Dean, Torrance, CA (US); Evan R. Dull, Greensboro, NC (US); Matthew J. Thompson, Torrance, CA (US); Mark A. Shurgot, Los Angeles, CA (US); David E. Shanks, Los Angeles, CA (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(21) Appl. No.: 11/716,268

(22) Filed: Mar. 9, 2007

Related U.S. Application Data
(60) Provisional application No. 60/781,106, filed on Mar. 10, 2006.

(51) Int. Cl. H04N 7/20

(52) U.S. Cl. 725/68

(57) ABSTRACT

An outcome prediction system viewed on a monitor. A system in accordance with the present invention comprises a plurality of contests, each contest having at least two outcomes, wherein a screen presented on the monitor allows for selection of one of the at least two outcomes for each of the contests in the plurality of contests, a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers, and a navigation bar; displayed on the monitor, to allow for viewing of a broadcast program on the monitor, wherein the broadcast program is related to at least one of the plurality of contests.

### BACKGROUND OF THE INVENTION

1. Field of the Invention

The present invention relates generally to satellite video systems, and in particular, to a method, apparatus, and article of manufacture for a custom on-screen display for data presentation.

2. Description of the Related Art

Satellite broadcasting of communications signals has become commonplace. Satellite distribution of commercial signals for use in television programming currently utilizes multiple feedhorns on a single Outdoor Unit (ODU), which supply signals to up to eight IRDs on separate cables from a multi switch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location and additional orbital locations without departing from the scope of the present invention.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Alternatively, uplink facilities 118 can send signals via cable 122 either in conjunction with uplink signals 116 or instead of uplink signals 116 to IRD 112, for display on monitor 114.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz, or in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses a system viewed on a monitor. A system in accordance with the present invention comprises a plurality of contests displayed as at least video presentations on the monitor, each contest having at least two outcomes, wherein a screen presented on the monitor allows for selection of one of the at least two outcomes for each of the contests in the plurality of contests, a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers, and a navigation bar; displayed on the monitor, to allow for viewing of a broadcast program on the monitor, wherein the broadcast program is related to at least one of the plurality of contests.

Such a system further optionally comprises a mosaic channel, displayed on the monitor and accessible by the screen displaying the plurality of contests, wherein the mosaic channel displays a plurality of video cells that are related to the plurality of contests, a summary area, displayed on the screen, wherein the summary area provides data related to contests not displayed on the monitor, a selector, displayed on the screen, to select different portions of the plurality of contests, an outcome being determined based on a betting line, and the plurality of contests being a tournament.

An apparatus for predicting the outcome of a plurality of contests in accordance with the present invention comprises a broadcast delivery system, comprising a transmitter and a receiver, a monitor, coupled to the receiver, for selectively displaying a plurality of broadcast programs, each broadcast program in the plurality of broadcast programs comprising a video presentation of at least one of the plurality of contests, each contest having at least two outcomes, wherein a screen presented on the monitor allows for selection of one of the at least two outcomes for each of the contests in the plurality of contests, a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers, and a navigation bar; displayed on the monitor, to allow for viewing of a broadcast program on the monitor, wherein the broadcast program is related to at least one of the plurality of contests.

Such an apparatus further optionally includes a mosaic channel, displayed on the monitor and accessible by the screen displaying the plurality of contests, wherein the mosaic channel displays a plurality of video cells that are related to the plurality of contests, a summary area, displayed on the screen, wherein the summary area provides data related to contests not displayed on the monitor, a second summary area, displayed on the screen, wherein the second summary area provides at least a portion of data not provided in the summary area, a selector, displayed on the screen, to select different portions of the plurality of contests, an outcome being determined based on a betting line, the plurality of contests being a tournament, and the broadcast delivery system being a satellite television delivery system.

Another exemplary system in accordance with the present invention compiles predictions related to a plurality of contests, and comprises a broadcast delivery system, comprising a transmitter and a receiver, a monitor, coupled to the receiver, for selectively displaying a plurality of broadcast programs, each broadcast program in the plurality of broadcast programs comprising a video presentation of at least one of the plurality of contests, and a scoring system, displayed on the monitor and coupled to the screen displaying the plurality of contests, the scoring system comprising a selection screen presented on the monitor for selection of an outcome for each of the contests in the plurality of contests, a scoring indicator, coupled to the selection screen, the scoring indicator having a first moniker indicating that a selected outcome was correct and a second moniker indicating that the selected outcome was incorrect, wherein the scoring system counts a number of first monikers and a number of second monikers and provides a total number of first monikers.

Such a system further optionally comprises a navigation bar, displayed on the monitor, to allow for viewing of a broadcast program on the monitor, wherein the broadcast program is related to at least one of the plurality of contests, the broadcast delivery system being a satellite television delivery system, an outcome being determined based on a betting line, and the plurality of contests being a tournament.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2A illustrates a typical six-cell matrix with a generic video feed in accordance with the present invention;

FIG. 2B illustrates a remote control used in the present invention;

FIGS. 3A-3C illustrate on-monitor displays of a data presentation page in accordance with the present invention; and

FIGS. 4A-4B illustrate data selection screens in accordance with an embodiment of the present invention.

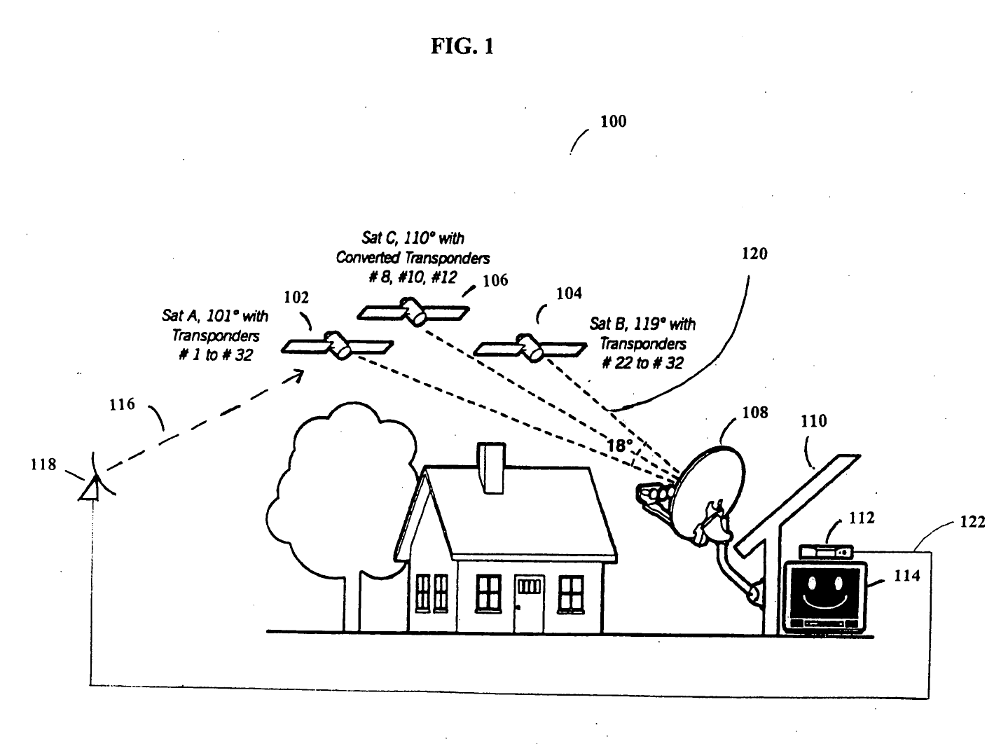

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Interactive Mosaic Channel Display Diagram

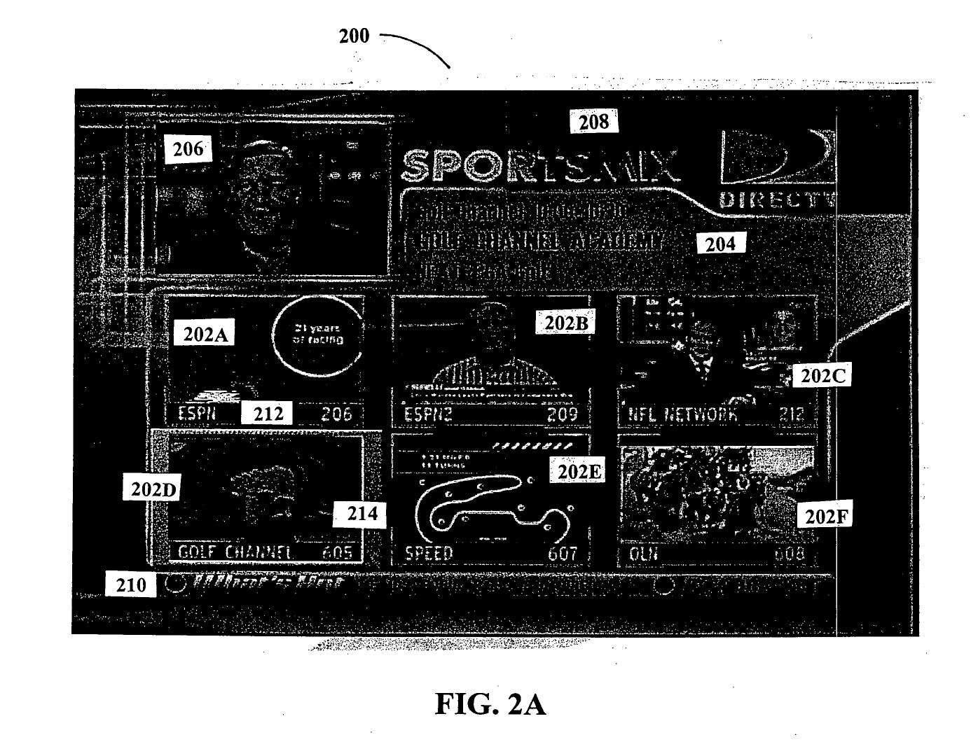

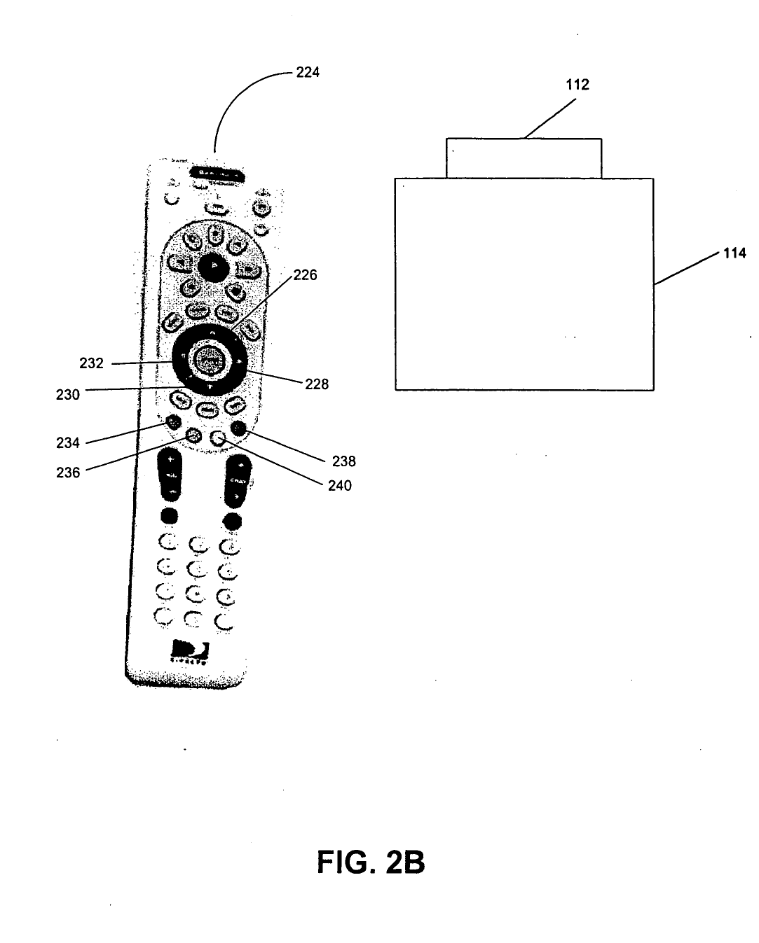

FIG. 2A illustrates a typical matrix with a generic video feed in accordance with the present invention.

Interactive mosaic channel 200 is shown as being displayed on monitor 114. Within interactive mosaic channel 200, there are a number of video cells 202A-202F and a text box 204, also referred to as an On Screen Display (OSD) 204. Optionally, the interactive mosaic channel 200 further comprises a separate video cell 206, also called a “barker cell” 206, a background video 208, and a control bar 210. The video cells 202A-F optionally comprise a channel identification (channel ID) portion 212. Further, cursor 214 is also optionally included to allow for interaction with each of the video cells 202A-202F and barker cell 206.

The number of video cells 202A-F can change based on the number of video cells 202 A-F desired. As the number of video cells 202A-F increases, of course, there must be a reduction in the size of the video cells 202A-F to ensure that the video cells are differentiated on the monitor 114. As the number of video cells 202A-F decreases, the size of the video cells 202A-F can increase, since there is more space available on monitor 114 to display video cells 202A-F.

Further, the placement of video cells 202A-F, barker cell 206, text box 204, and control bar 210 is not limited to the positions on monitor 114 as shown in FIG. 2A. These elements can be displayed anywhere on monitor 114 without departing from the scope of the present invention.

As there are multiple video feeds and video cell 202A-F and barker cell 206 being presented, each video cell 202A-F and barker cell 206, as well as background video 208 and possibly control bar 210, have associated audio portions that can be played. Presenting more than one audio stream may be confusing; as such, it is typical that only one audio stream of information is presented at a given time. However, each of the video feeds may also have closed-captioning information associated with it, and selection of a closed-captioned presentation, rather than an audio presentation, can be performed as described herein.

Video Cells

Video cells 202A-F each comprise a separate viewer channel of programming. So for example, in an interactive mosaic channel that is focused on news programming, cell 1 could contain the video programming associated with the viewer channel of FOX News Channel, cell 2 could contain the video programming associated with the viewer channel of CNN, cell 3 could contain the video programming associated with the viewer channel of Headline News, cell 4 could contain the video programming associated with the viewer channel of MSNBC, cell 5 could contain the video programming associated with the viewer channel of The Weather Channel, and cell 6 could contain the video programming associated with the viewer channel of C-SPAN. The placement and video programming content for each video cell 202A-F can depend on a wide variety of factors, such as Nielsen ratings for a given channel, whether a given channel is available on a specific viewer's programming package, viewer channel number (lowest to highest or highest to lowest) or can be decided or changed based on programming that is present on one or more of the viewer channels available for the interactive mosaic channel. For example, and not by way of limitation, an important vote on the floor of the Senate may be taking place, and a decision can be made to change the placement of C-SPAN from video cell 202F to video cell 202A for a period of time. Changes in presentation for the interactive mosaic channel 200 are discussed below.

Within each of the video cells 202A-F is a channel identification (ID) box 212. Typically, the channel ID box 212 indicates to the viewer the moniker or name that is associated with the video feed being shown in that respective video cell 202A-F, and the viewer channel number associated with the video feed being shown in that respective video cell 202A-F. For example and not by way of limitation, in video cell 202A, which as described above, is showing the video feed for ESPN, channel ID box 212 would indicate “ESPN” as well as, optionally, a channel number, e.g., “206” to indicate to the viewer that the video feed being shown in video cell 202A is that of ESPN, and that the viewer is accustomed to seeing this full-monitor 114 video programming on viewer channel 206.

Other information may also appear in channel ID box 212, such as an indication that the video feed that is being presented in the associated video cell 202A-F is a “user favorite” channel, the channel ID box 212 may be presented in a different color or video texture to indicate that the video feed that is being presented in the associated video cell 202A-F is a channel that presents programming that adults may wish to block from their children's view or has closed-captioning available, etc. Many possibilities are available within the scope of the present invention to present various types of video information within channel ID box 212 for viewer selection and benefit. The channel ID box 212 may also appear without a video cell 202A-F for those video feeds that are channel blocked via parental control, or otherwise unavailable to a specific viewer because of the viewer's programming package or other reasons.

Text Box

Text box 204 contains textual information that is useful to the viewer, and this information can change depending on the viewer's selection of interactive services as described herein. For example, the text box 204 can contain a generic statement about the genre of the interactive mosaic channel 200, or statements directed to a selected video cell 202A-F or information related to the channel ID box 212 to describe to a user the meaning of the information presented in the channel ID box 212 or other information related to the video cell 202A-F and channel ID box 212. The text box can also scroll to present additional information to the viewer that does not all fit within text box 204 at a given time.

There can also be default text associated with each interactive mosaic channel 200, and, depending on the capabilities of IRD 112, each time an interactive mosaic channel 200 is tuned to, a default descriptive text shall be displayed in the text box 204.

Barker Cell

Barker cell 206 is a presentation of video data that can relate to the video cells 202A-F that are present in interactive mosaic channel 200. For those interactive mosaic channels 200 that have the optional barker cell 206, the barker cell 206 can use audio or video clues to direct the user to one of the video cells 202A-F for more information on a given topic, or provide an overview of the information presented within the video cells 202A-F. For example, the audio and video associated with barker cell 206 in a news format can be a series of stories that are being covered in more depth on the viewer channels being shown in video cells 202A-F, and the barker cell 206 audio and video can then direct the viewer to tune the IRD 112 or monitor 114 to a specific video cell 202A-F for more information on that topic. The barker cell 206 can also be used to provide an overview of the news stories, either those presented in video cells 202A-F or other news stories of interest, without directing the viewer to one of the video presentations being discussed in the video feeds shown in video cells 202A-F.

Barker cell 206 can present audio and video information that is not available on any other viewer channel that is accessible to IRD 112 or monitor 114, other than within the barker cell 206 of the interactive mosaic channel 200. When the barker cell 206 presents audio and video information that is not present on any other viewer channel accessible to IRD 112 or monitor 114, then the barker cell 206 does not have an associated channel ID box 212.

Background Video

Background video 208 is typically a backdrop for the interactive mosaic channel 200. The background video 208 can be related to the genre of the interactive mosaic channel 200; for example, in a news environment, the background video 208 can be related to a top news story, the stock market exchange building, a prominent government building, etc. The background video 208 can be changed or can be a dynamic video depending on the desires of the editorial staff or viewer preferences. Further, the background video 208 can be a logo or other indicator of the source of the interactive mosaic channel 200, such as DIRECTV.

Interactive Features

FIG. 2B illustrates a remote control used in the present invention.

Typically, IRD 112 and monitor 114 are controlled by a remote control device 224, which allows viewers a convenient way to control audio volume, channel selection, and other features and display characteristics from a distance away from the IRD 112 and/or monitor 114.

Each video cell 202A-F has an associated channel ID box 212, and one of the video cells, cell 202D, has a cursor 214 surrounding that specific video cell 202 and, optionally, channel ID box 212. The cursor 214 indicates that the specific video cell 202 and channel ID 212 has been selected by the viewer. The cursor 214 is typically controlled by buttons 226-232, but can be controlled by other buttons on the remote control 224 if desired.

By selecting a given video cell 202A-F, the viewer is selecting a specific characteristic associated with that given video cell 202A-F, or associated video feed used to generate that video cell 202A-F. In most instances, when the viewer selects a given video cell 202, the audio portion associated with the selected video cell 202 will be presented to the viewer, rather than the audio portion associated with the barker cell 206 or a generic audio track that is associated with interactive mosaic channel 200. Further, selection of a given video cell 202A-F with cursor 214 may also select a closed captioning data stream associated with the selected video cell 202, depending on the availability of such a data stream and/or other settings that a viewer has selected. Cursor 214 can be moved to any of the video cells 202A-F, and, optionally, can be moved to select text box 204 or control bar 210.

When cursor 214 is moved to a given video cell 202A-F via buttons 226-232, text box 204 also may undergo a change in information. Typically, when the video cell 202A-F is selected by the viewer, indicated by the presence of cursor 214, text box 204 will present the information in the Advanced Program Guide (APG) that is associated with the viewer channel selected by cursor 214. The APG typically includes information on the program or “show” that is currently being presented by the viewer channel shown in video cell 202A-F, as well as the time that show is being aired and the next show to be aired on that viewer channel. Other information, either in the APG or external to the APG, can also be displayed in the text box 204 when the cursor is moved to a given video cell 202A-F.

As such, the viewer can “interact” with the interactive mosaic channel 200 and decide which audio track to listen to, find out a plot line of each of the shows being presented in the various video cells 202, find out what is going to be aired next in the various viewer channels being presented in video cells 202, or listen to generic audio from the barker cell 206 or associated with the interactive mosaic channel 200 itself while variously viewing the video presentations in the video cells 202. If a specific video cell 202 presents video information that is of interest to a viewer, then the viewer can move cursor 214, via a remote control command, to a given video cell 202, and listen to the audio associated with that video cell 202 and find out more about that viewer channel in text box 204.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control 224 (typically the “select” button on a DIRECTV remote control). This will tune the IRD 112 or monitor 114 to that viewer channel, which will then be presented full-screen to the viewer as in a normal television monitor 114 viewing format.

The barker cell 206, since it typically contains audio and video information that is not located on any viewer channel other than the interactive mosaic channel 200, cannot typically be selected for full screen viewing by the viewer on monitor 114. However, the barker cell 206 can be selected for full monitor 114 viewing, or at least enough of the monitor 114 to allow for changes in the video cells 202 as described below, to allow for changes in the interactive mosaic channel 200 and in the control bar 210 in near-real-time.

Control Bar

The Control Bar 210 (also called the Attract Icon or the Attract Icon Bar) The control bar 210 allows for instant, on-screen access to several data sources that allow the viewer to access data related to that being shown in the video cells 202A-F as well as other viewer channels available within system 100. Those IRDs 112 that have interactive capabilities have special buttons that correspond to the icons that appear on the control bar 210. Each icon/button directs the viewer to a different screen, such as special events, or, in the case of the present invention, data related to real-time or near-real-time viewership of channels within system 100. Each screen can have sub-screens that further allow related data to be viewed or otherwise analyzed by the viewer.

For example, and not by way of limitation, one of the remote control 224 buttons, e.g., the “red” button 234, indicated by text and/or graphics on control bar 210, may take a viewer to the “What's Hot” page, where viewers can review data related to viewership of shows currently being aired within system 100.

Similarly, a “special” page can be accessed by pressing a different button on the remote control 224, e.g., the “green” button 236, or the blue button 238 or yellow button 240, where viewers can view a channel or other data page. The special page can be reprogrammed by the system provider or the viewer based on time, or, in the case of interactive mosaic channel 200, can be done by genre. For example, and not by way of limitation, the special page can be assigned to the NCAA bracket for a “Sports” mosaic channel 200, and, if the viewer changes to a “News” mosaic channel 200, the special page can be a breaking news channel or news recap video loop that is provided by the system provider. There can be more than one special “page” that is accessible from the buttons 234-240, or other buttons on the remote control 224, if desired.

Monitor Displays

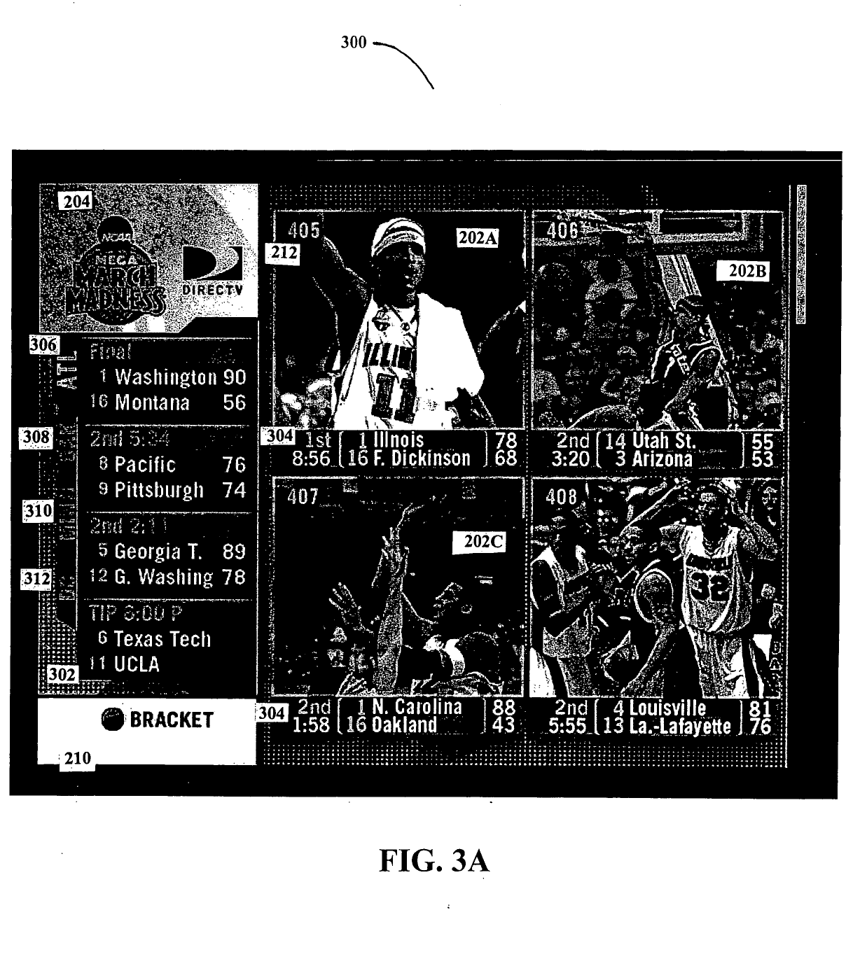

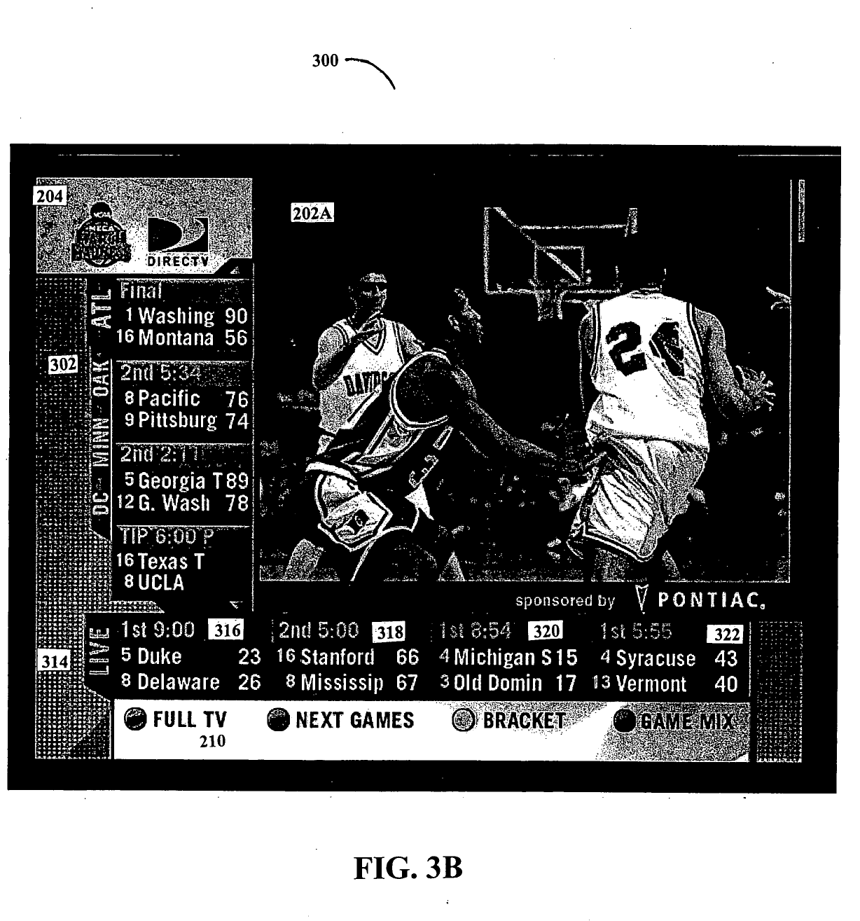

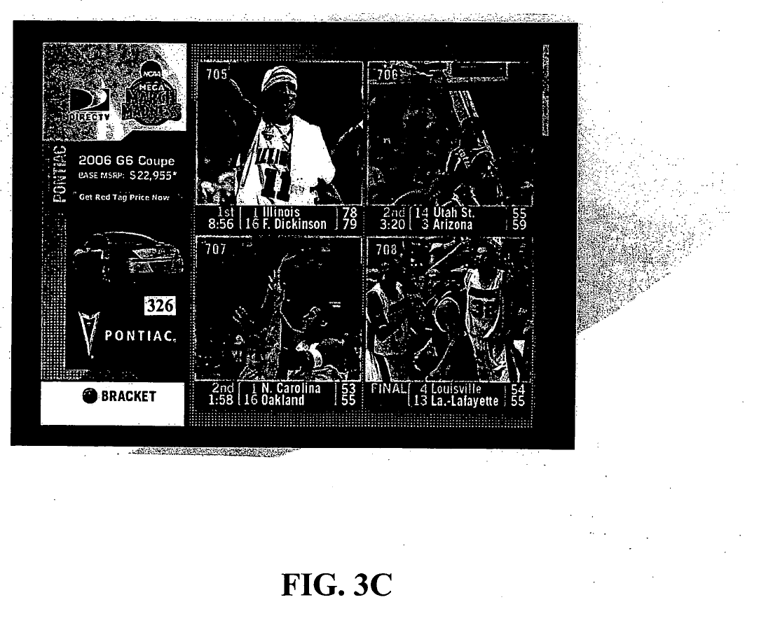

FIGS. 3A-3C illustrate on-monitor displays of data presentation pages in accordance with the present invention.

FIG. 3A illustrates screen 300, which comprises four video cells 202A-202D, text box 204, control bar 210, and summary area 302. Within video cells 202A-D, channel ID 212 is shown, along with data area 304.

Summary area 302 uses tabs 306-312 to provide different views of data that may be of interest to the viewer. By pressing one of the buttons 234-240, the viewer can maneuver between different tabs 306-312. For example, and not by way of limitation, tab 306 is uppermost as shown on screen 300, indicating to the viewer that the data associated with tab 306, namely, the games that are being contested in the Atlanta bracket of the NCAA Men's basketball tournament, is being displayed in summary area 302. When one of the buttons 234-240 is pressed, tab 308 will become uppermost, and the data associated with tab 308, namely, the games that are being contested in the Oakland bracket of the NCAA Men's basketball tournament, would be displayed in summary area 302.

For both summary area 302 and data area 304 of the video cells 202, not only are scores indicated for each of the contested games, but the seeding of each of the teams, the time remaining in the game, whether the game is in the first or second half, and a current leader is indicated. The current leader can be indicated by a different color background, or different colored letters appearing within summary area 302 or data area 304, or other visual indicators that would provide that information to a viewer. Further, when the game enters a critical point, such as the final two minutes in a half or in the game, or when the game is in overtime, the time can be displayed with a different color or in bold or other visual clue to indicate to the viewer that a critical point in the game has been reached. For example, and not by way of limitation, in video cell 202C, the time remaining in the second half of the game is 1:58. This can be displayed in a red color, or with a red background, to quickly indicate to the viewer that the game is at a critical junction. The score for North Carolina, or the entire background behind the team name that is leading the game, can be displayed in a different color to indicate that they are leading. The viewer can then quickly determine whether the game that is at a critical junction should be viewed, which can be done by moving a cursor to the video cell 202A-D of interest and selecting that video cell, or whether the score, teams, or other issues associated with that game are not of interest to the viewer at that time.

The data within summary area 302 and data area 304 is typically maintained as live, up-to-the-minute data reports that provide current scores, times, and other data associated with either video cells 202 or other data that is typically related to video cells 202 by genre. For example, the data in summary area 302 is related to other games that are going on in the NCAA tournament, while the data in data area 304 is related to the video cells 202A-D that are displayed on screen 300.

Other indicators, such as that the game is completed, the game has not started, or there is a time-out in the game, are also possible displays of data within summary area 302 and data area 304.

FIG. 3B illustrates another on-monitor display of the present invention.

Screen 300 again shows a video cell 202A, text box 204, and control bar 210, with summary area 302. Video cell 202A is now wrapped with an additional summary area 314, where data cells 316-322 are presented with data associated with the video presented in video cell 202A and other video cells that are not currently being shown. For example, data cell 316 may provide the score, time remaining, and other data about video cell 202A, whereas data cells 318-322 provide data about other games that are currently in progress. The data in summary area 302 may be repeated in summary area 314, or the data that is presented in summary area 304 may be unrelated and separately manipulated from data in summary area 314.

Control bar 210 now also provides additional functions for buttons 234-240 than shown in FIG. 3A. Button 234 may take the video shown in video cell 202A to a full screen condition, button 236 may look at additional or upcoming events such as the next round of televised games, button 238 may go to a separate data screen, and button 240 may take the viewer back to a mosaic channel display similar to that shown in FIG. 3A.

Further, a data overlay 324 can be placed within video cell 202A, or elsewhere on screen 300, to provide additional data to the viewer. For example, data overlay can show sponsorship information about the program shown in video cell 202A or on screen 300, or can provide updates to other games or data events associated with the mosaic channel. An example of such other games or data events may be that a specific game is going into the final two minutes, that an upset occurred in another game, or that highlights of a game just completed are available for viewing.

FIG. 3C illustrates another use for the summary area of the present invention.

Presentation 326 is shown in summary area 302, and presentation 326 may be an advertisement, video advertisement, or other data that the service provider decides to present to viewers in summary area 302. Further, presentation 326 may have interactive features similar to those described herein, where the cursor can be placed on summary area 302 and the user is directed to another data screen or channel based on the content of presentation 326. Presentation 326 can be shown in summary area 302 or summary area 314, or both, without departing from the scope of the present invention.

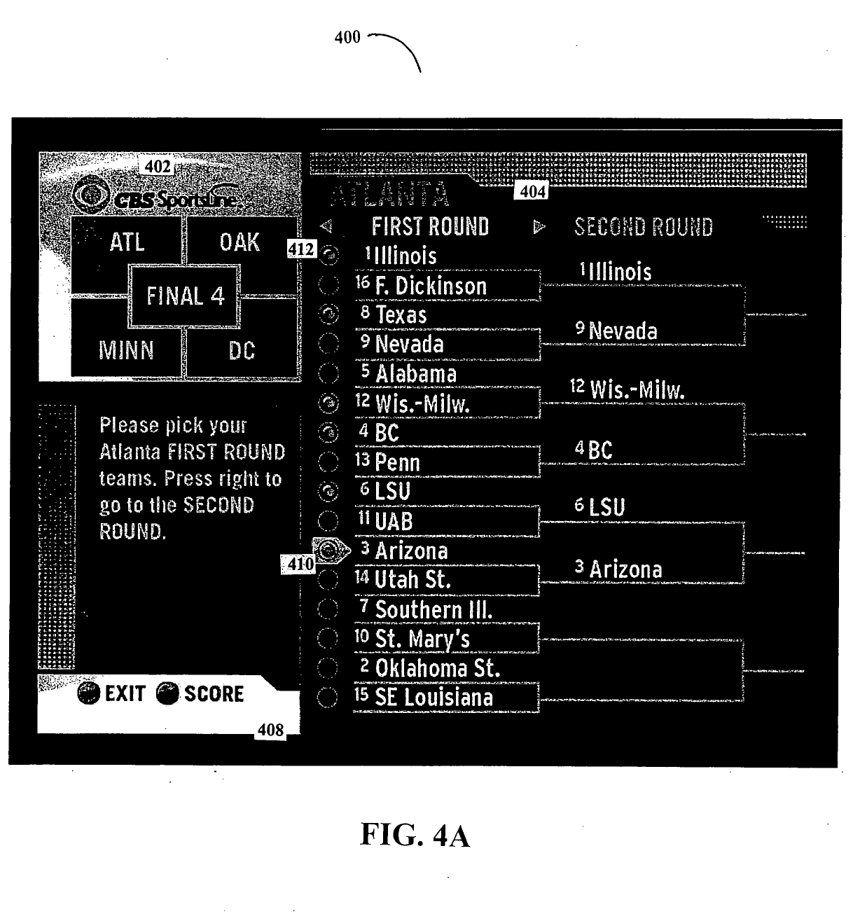

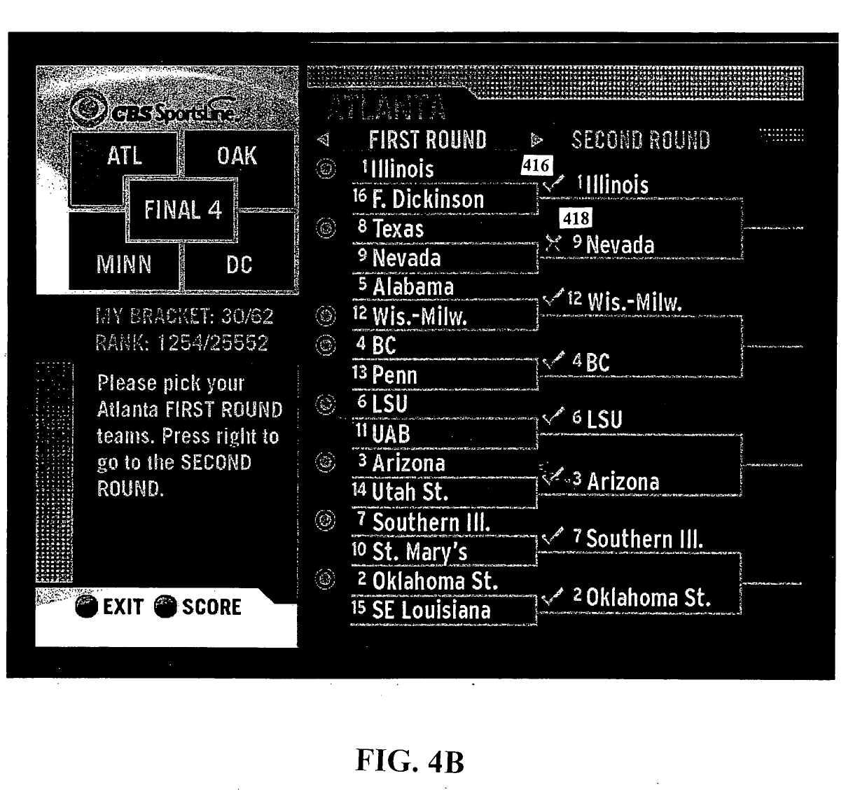

FIGS. 4A-4B illustrate data selection screens in accordance with an embodiment of the present invention.

FIG. 4A illustrates screen 400, which comprises bracket selector 402, data selection area 404, text box 406, and navigation bar 408. Although shown by way of example using the NCAA Men's Basketball Tournament, it is envisioned that the present invention can be applied to other bracket sporting events, such as the National Basketball Association playoffs, or other sporting events, without departing from the scope of the present invention.

Selector 402 allows the viewer to use remote control 224 to select which data selection area 404 will be used to enter data. A highlight or other visual indicator is made within one of the areas of selector 402 to indicate to the viewer which of the areas of selector 402 is being viewed in data selection area 404.

Data selection area 404 shows the viewer the data that is to be selected for the viewer's “picks” as to which team in a given contest will win. The data selection area further comprises a cursor 410 and radio buttons 412. Cursor 410 is manipulated by buttons on remote control 224 to highlight one of the radio buttons, which is then selected by another button on remote control 224 to indicate which of the teams the viewer thinks will win a given contest. Such a choice may be made based on additional information, e.g., the betting line published by one or more gambling casinos, sports books, etc., which can be factored into the selection and whether or not a team actually “won” the contest. For example, and not by way of limitation, typically the first seed in a bracket is expected to defeat the 16^{th} seed in that bracket. For an experienced viewer, the first seed in a given bracket is usually a safe and obvious choice to win that particular game. However, when a betting line is used in conjunction with the seeding, such that the first seed must win the game by more than 20 points, the selection of which team to pick as the winner may be a little less intuitive, and may provide additional excitement in what otherwise would not be a closely contested game. The present invention can display the betting line of a given game within data selection area 404 to assist the viewer in making their selections if desired.

Text box 406 provides information or other data to the viewer to assist the viewer in navigating through screen 400. Navigation bar 408 provides the monikers for buttons on the remote control 224 to control certain functions of screen 400, such as returning the viewer to another screen (typically screens 300 shown in FIGS. 3A-3C), or other data screens 400 of the present invention. The viewer then continues the process of selecting winners of each game in the tournament or playoff structure until a champion is selected. Other selections, such as tie-breaker selections, can be made without departing from the scope of the present invention.

FIG. 4B illustrates another data screen of an embodiment of the present invention.

Once initial choices are made using radio buttons 412 and cursor 410, and the games that are displayed in data selection area 404 have been completed, screen 414 can be displayed with monikers 416 and 418, which indicate whether the viewer's selections were correct. Moniker 416 shows those games that were selected correctly; this may be a colored moniker 416, such as a green checkmark or other indicator to show that these predictions were made correctly by the viewer. The correct indicating moniker 416 may also take into account the betting line, and, although a specific team may have won the actual game, did not win by more than the betting line and therefore, a different moniker, such as moniker 418 may be shown. Moniker 418 is typically of a different shape than moniker 416, and can also be of a different color than moniker 416, so the viewer can easily determine which of the games were predicted correctly.

In both FIGS. 4A and 4B, the viewer would then make their picks of which team would win each game in the tournament, playoff structure, etc. based on the different brackets shown in selector 402. Once all the bracket selections are made, including the eventual tournament champion, additional screens 400 may be used for tie-breaker information, such as correctly selecting the total number of points in the final game of the tournament, etc.

Points can then be assigned by the system provider as shown in text box 406, or as some other portion of screen 400, to indicate to the viewer that their picks rank at a certain point with respect to other viewers that have participated in the prediction of the outcomes of the contests. Further, the system provider can make a pseudo-administrator function available to individuals, with or without a fee, such that groups of friends, co-workers, etc., can have private tournament pools for their private enjoyment. The points per game in each round, rules for selection, etc., can be determined by the pseudo-administrator, and results of the selections for each member of the group can be displayed rather than or along with the results of how an individual viewer did with respect to other viewers in the select group or with respect to all other viewers choosing to participate.

For viewers that achieve a certain score, certain number of games correctly selected, or who end up in a top percentage of all participating viewers in the prediction selection process described herein, the system provider can provide additional services for reduced cost, e.g., two pay-per-view movies for the price of one, or can provide discounts to monthly rates, as an incentive to participate. Further, the predictions can be used for gaming or gambling purposes where such activities are sanctioned, e.g., casinos.

So, for example, and not by way of limitation, the present invention can be mounted in a kiosk, or an in-room monitor 114, that is located in a casino or hotel. A patron can make their selections, place a wager, and if the patron correctly predicts the outcome of enough games in the tournament, would win money or a prize from the establishment or other prize sponsor. Betting lines, or a pure win/lose system can be used, based on the desires of the casino operators.

Conclusion

The present invention comprises an outcome prediction system viewed on a monitor. A system in accordance with the present invention comprises a plurality of contests displayed as at least video presentations on the monitor, each contest having at least two outcomes, wherein a screen presented on the monitor allows for selection of one of the at least two outcomes for each of the contests in the plurality of contests, a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers, and a navigation bar; displayed on the monitor, to allow for viewing of a broadcast program on the monitor, wherein the broadcast program is related to at least one of the plurality of contests.

Such a system further optionally comprises a mosaic channel, displayed on the monitor and accessible by the screen displaying the plurality of contests, wherein the mosaic channel displays a plurality of video cells that are related to the plurality of contests, a summary area, displayed on the screen, wherein the summary area provides data related to contests not displayed on the monitor, a selector, displayed on the screen, to select different portions of the plurality of contests, an outcome being determined based on a betting line, and the plurality of contests being a tournament.

An apparatus for predicting the outcome of a plurality of contests in accordance with the present invention comprises a broadcast delivery system, comprising a transmitter and a receiver, a monitor, coupled to the receiver, for selectively displaying a plurality of broadcast programs, each broadcast program in the plurality of broadcast programs comprising a video presentation of at least one of the plurality of contests, each contest having at least two outcomes, wherein a screen presented on the monitor allows for selection of one of the at least two outcomes for each of the contests in the plurality of contests, a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers, and a navigation bar; displayed on the monitor, to allow for viewing of a broadcast program on the monitor, wherein the broadcast program is related to at least one of the plurality of contests.

Such an apparatus further optionally includes a mosaic channel, displayed on the monitor and accessible by the screen displaying the plurality of contests, wherein the mosaic channel displays a plurality of video cells that are related to the plurality of contests, a summary area, displayed on the screen, wherein the summary area provides data related to contests not displayed on the monitor, a second summary area, displayed on the screen, wherein the second summary area provides at least a portion of data not provided in the summary area, a selector, displayed on the screen, to select different portions of the plurality of contests, an outcome being determined based on a betting line, the plurality of contests being a tournament, and the broadcast delivery system being a satellite television delivery system.

Another exemplary system in accordance with the present invention compiles predictions related to a plurality of contests, and comprises a broadcast delivery system, comprising a transmitter and a receiver, a monitor, coupled to the receiver, for selectively displaying a plurality of broadcast programs, each broadcast program in the plurality of broadcast programs comprising a video presentation of at least one of the plurality of contests, and a scoring system, displayed on the monitor and coupled to the screen displaying the plurality of contests, the scoring system comprising a selection screen presented on the monitor for selection of an outcome for each of the contests in the plurality of contests, a scoring indicator, coupled to the selection screen, the scoring indicator having a first moniker indicating that a selected outcome was correct and a second moniker indicating that the selected outcome was incorrect, wherein the scoring system counts a number of first monikers and a number of second monikers and provides a total number of first monikers.

Such a system further optionally comprises a navigation bar, displayed on the monitor, to allow for viewing of a broadcast program on the monitor, wherein the broadcast program is related to at least one of the plurality of contests, the broadcast delivery system being a satellite television delivery system, an outcome being determined based on a betting line, and the plurality of contests being a tournament.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

What is claimed is:

1. An outcome prediction system viewed on a monitor, comprising:
a plurality of contests displayed as at least video presentations on the monitor, each contest having at least two outcomes, wherein a screen presented on the monitor allows for selection of one of the at least two outcomes for each of the contests in the plurality of contests;
a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers; and
a navigation bar; displayed on the monitor, to allow for viewing of a broadcast program on the monitor, wherein the broadcast program is related to at least one of the plurality of contests.

2. The outcome prediction system of claim 1, further comprising a mosaic channel, displayed on the monitor and accessible by the screen displaying the plurality of contests, wherein the mosaic channel displays a plurality of video cells that are related to the plurality of contests.

3. The outcome prediction system of claim 2, further comprising a summary area, displayed on the screen, wherein the summary area provides data related to contests not displayed on the monitor.

4. The outcome prediction system of claim 3, further comprising a second summary area, displayed on the screen, wherein the second summary area provides at least a portion of data not provided in the summary area.

5. The outcome prediction system of claim 3, further comprising a selector, displayed on the screen, to select different portions of the plurality of contests.

6. The outcome prediction system of claim 1, wherein an outcome is determined based on a betting line.

7. The outcome prediction system of claim 1, wherein the plurality of contests is a tournament.

8. An apparatus for predicting the outcome of a plurality of contests, comprising:
a broadcast delivery system, comprising a transmitter and a receiver;
a monitor, coupled to the receiver, for selectively displaying a plurality of broadcast programs, each broadcast program in the plurality of broadcast programs comprising a video presentation of at least one of the plurality of contests, each contest having at least two outcomes, wherein a screen presented on the monitor allows for selection of one of the at least two outcomes for each of the contests in the plurality of contests;
a scoring system, displayed on the monitor and coupled to the screen displaying the plurality of contests, the scoring system providing a first moniker indicating that a selected outcome was correct and a second moniker indicating that the selected outcome was incorrect, wherein the scoring system counts a number of first monikers and a number of second monikers and provides a total number of first monikers; and
a navigation bar; displayed on the monitor, to allow for viewing of a broadcast program on the monitor, wherein the broadcast program is related to at least one of the plurality of contests.

9. The apparatus of claim 8, further comprising a mosaic channel, displayed on the monitor and accessible by the screen displaying the plurality of contests, wherein the mosaic channel displays a plurality of video cells that are related to the plurality of contests.

10. The apparatus of claim 9, further comprising a summary area, displayed on the screen, wherein the summary area provides data related to contests not displayed on the monitor.

11. The apparatus of claim 10, further comprising a second summary area, displayed on the screen, wherein the second summary area provides at least a portion of data not provided in the summary area.

12. The apparatus of claim 11, further comprising a selector, displayed on the screen, to select different portions of the plurality of contests.

13. The apparatus of claim 8, wherein an outcome is determined based on a betting line.

14. The apparatus of claim 8, wherein the plurality of contests is a tournament.

15. The apparatus of claim 8, wherein the broadcast delivery system is a satellite television delivery system.

16. A system for compiling predictions related to a plurality of contests, comprising:
a broadcast delivery system, comprising a transmitter and a receiver;
a monitor, coupled to the receiver, for selectively displaying a plurality of broadcast programs, each broadcast program in the plurality of broadcast programs comprising a video presentation of at least one of the plurality of contests, and
a scoring system, displayed on the monitor and coupled to the screen displaying the plurality of contests, the scoring system comprising
a selection screen presented on the monitor for selection of an outcome for each of the contests in the plurality of contests;
a scoring indicator, coupled to the selection screen, the scoring indicator having a first moniker indicating that a selected outcome was correct and a second moniker indicating that the selected outcome was incorrect, wherein the scoring system counts a number of first monikers and a number of second monikers and provides a total number of first monikers.

17. The system of claim 17, further comprising a navigation bar; displayed on the monitor, to allow for viewing of a broadcast program on the monitor, wherein the broadcast program is related to at least one of the plurality of contests.

18. The system of claim 17, wherein the broadcast delivery system is a satellite television delivery system.

19. The apparatus of claim 18, wherein an outcome is determined based on a betting line.

20. The apparatus of claim 19, wherein the plurality of contests is a tournament.
